(19) United States
(12) Patent Application Publication
(10) Pub. No.: US 2006/0013086 A1
(43) Pub. Date: Jan. 19, 2006

(54) Method for generating write pulse in optical disk drives

(75) Inventors: Jan-Tang Wu, Taipei (TW); K.Y. Sean Chien, Taipei (TW)

Correspondence Address: BRUCE H. TROXELL;SUITE 1404, 5205 LEESBURG PIKE, FALLS CHURCH, VA, 22041, US

(73) Assignee: ALi Corporation

(21) Appl. No.: 10/989,371

(22) Filed: Nov. 17, 2004

(30) Foreign Application Priority Data
Jul. 16, 2004 (TW) 93121236

(51) Int. Cl. G11B 7/12

(52) U.S. Cl. 369/47.5; 369/47.53; 369/59.1

(57) ABSTRACT

The present invention discloses a method for generating a write pulse in an optical disk drives, which comprises the steps of: determining an encoded signal; providing a lookup table that integrates a plurality of various types of parameters used for a write pulse signal in different numbers of cycles for encoding and decoding signals; determining the parameters used for the write pulse signal by checking with the lookup table according to the number of cycle corresponding to the encoded signal; and forming the write pulse signal corresponding to the encoded signal according to the parameters obtained from the lookup table. With this invention, an optical disk burner can produce the write pulse with different waveforms to comply with the duplication requirements for various optical disks.

### FIELD OF THE INVENTION

The present invention relates to a method for generating write pulse in optical disk drives, and more particularly, to a method for optical disk drives to generate write pulse that is adapted for recordable/rewritable optical disks of different specifications.

### BACKGROUND OF THE INVENTION

At present, there are various recordable/rewritable optical disks, such as CD-R. CD-RW, DVD-R, DVD−RW, DVID+R and DVD+RW, etc., in the market and each type of recordable/rewritable optical disk requires its own write pulse format for duplicating data onto the same. That is, a CD-R disk can only be used in a burner supporting CD-R format, and similarly, a DVD-R disk can only be used in a burner supporting DVD-R format.

Since a compact disk (CD) is restricted physically by its tracks, therefore it is necessary to convert an 8-bit data into a 14-channel-bit data by using the eight to fourteen modulation (EFM) when an 8-bit data is copied onto a CD. Therefore, while duplicating an 8-bit data onto a CD, it is necessary to produce an EFM write pulse for copying the 8-bit data onto the CD.

In the EFM process, the final encoding result follows the existing rules (3T˜11T). Therefore, each section of the 14-channel-bit code follows the rules of 3T˜11T, that is, 3T refers to two “0” sandwiched between two “1”s; 4T refers to three “0” sandwiched between two “1”s; . . . ; and 11T refers to ten “0” sandwiched between two “1”s, while the relating write pulse can be generated accordingly.

Please refer to FIG. 1, which is an illustration showing a write pulse signal for write strategy of a prior-art CD-R disc. This write pulse is composed of a wpo1 signal and a wpo2 signal, and the wpo1 signal and the wpo2 signal are generated according to the number of T's corresponding to each section coded by the EFM, that is, the parameters used for delaying the amplitude of the wpo1 signal and the wpo2 signals are obtained with respect to the number of T's, wherein 0<R₁ₚ<64H, 0<W₁ₚ<64H, 31H<(R₁ₚ+W₁ₚ)<128H, 0<D_{end}<64H and H=(1/32)T.

Please refer to FIG. 2, which is an illustration showing a write pulse signal for write strategy of a prior-art CD-RW disc. This write pulse is also composed of a wpo1 signal and a wpo2 signal, but more parameters are used for the wpo1 signal and the wpo2 signal in the CD-RW duplication than those in the CD-R duplication, where 0<R₁ₚ<64H, 0<W₁ₚ<64H, 31H<(R₁ₚ+W₁ₚ)<64H, 0<R₂ₚ<32H, 0<W₂ₚ<32H, 0<(R₂ₚ+W₂ₚ)<32H, 0<R_{LP}<32H, 0<W_{LP}<32H, 0<(R_{LP}+W_{LP})<32H, 0<D_{end}<64H and H=(1/32)T. Further, while the write pulse is defined within 3T, the conditions of R₂ₚ=R_{LP} and W₂ₚ=W_{LP} must be established.

More parameters are used for producing a write pulse for DVD disc than those in CD duplication, and there are even various modes used for representing the write pulse signal of each T's in DVD duplication. Please refer to FIGS. 3 and 4, which are illustrations respectively showing a write pulse signal of a DVD-R pulse mode and a DVD-R block mode. In FIGS. 3 and 4, while duplicating a DVD-R disk under different modes, the write pulses with the same number of cycles (T) will have different waveforms and the thus parameters of the write pulse signals are also different accordingly.

Please refer to FIG. 5 for an illustration showing a write pulse signal for write strategy of DVD−RW disc. Besides the feature that DVD−RW of the same number of cycles (T) will have different write pulse waveforms while it is subjected to different duplication modes, the DVD−RW of the same number of cycles (T) also has different write pulse waveforms while it is subjected different speeds of duplication.

Therefore, different types of optical disks have to use their corresponding pulse write signals. When a user holds an optical disk, the user needs to have an optical disk drive capable of generating the write pulse required for duplicating such optical disk. The duplication process requires users to have a burner that supports the format of that particular disk, which is very inconvenient to users.

In view of the foregoing shortcoming, the present invention provides a method for generating write pulse in optical disk drives, which can generate write pulse signals of different waveforms so as to meet the duplication requirements for various types of optical disks.

### SUMMARY OF THE INVENTION

The primary objective of the invention is to provide a method capable of generating different write pulse waveforms to meet the duplication requirements of various types of optical disks. To achieve this objective, the present invention provides a method for generating write pulse in optical disk drives, comprising the steps of: determining an encoded signal; providing a lookup table that integrates a plurality of various types of parameters used for a write pulse signal in different numbers of cycles for encoding and decoding signals; determining the parameters used for the write pulse signal by checking with the lookup table according to the number of cycle corresponding to the encoded signal; and forming the write pulse signal corresponding to the encoded signal according to the parameters obtained from the lookup table.

The method for generating write pulse in optical disk drives according to a preferred embodiment of the invention further comprises the steps of: dividing the encoded signal into four sections and referring to the lookup table respectively according to the cycle number representing each section of the encoded signal. Moreover, Several basic wave signals using parameters obtained from the checking of the lookup table are combined to form a write pulse signal, wherein the number of parameters used by these basic wave signals represents the number of turning point of the rising edges of the basic wave signals. The high/low potentials of these parameters are used to determine the waveform potential of the basic waveforms, and the values of the parameters used by these basic waveforms stand for the delay time of the waveform potential of the basic wave signal.

### BRIEF DESCRIPTION OF THE DRAWINGS

FIG. 1 is an illustration showing a write pulse signal for write strategy of a prior-art CD-R disc.

FIG. 2 is an illustration showing a write pulse signal for write strategy of a prior-art CD-RW disc.

FIGS. 3 and 4 are illustrations respectively showing a write pulse signal of a DVD-R pulse mode and a DVD-R block mode.

FIG. 5 is an illustration showing a write pulse signal for write strategy of DVD−RW disc.

FIG. 6 is a flow chart of the method for generating a write pulse signal in an optical disk drive according to a preferred embodiment of the present invention.

FIG. 7 is an illustration showing the method for generating a write pulse signal in an optical disk drive according to a preferred embodiment of the present invention.

FIG. 8 is a lookup table according to a preferred embodiment of the present invention.

FIG. 9 is an illustration showing a write pulse signal of FIG. 7.

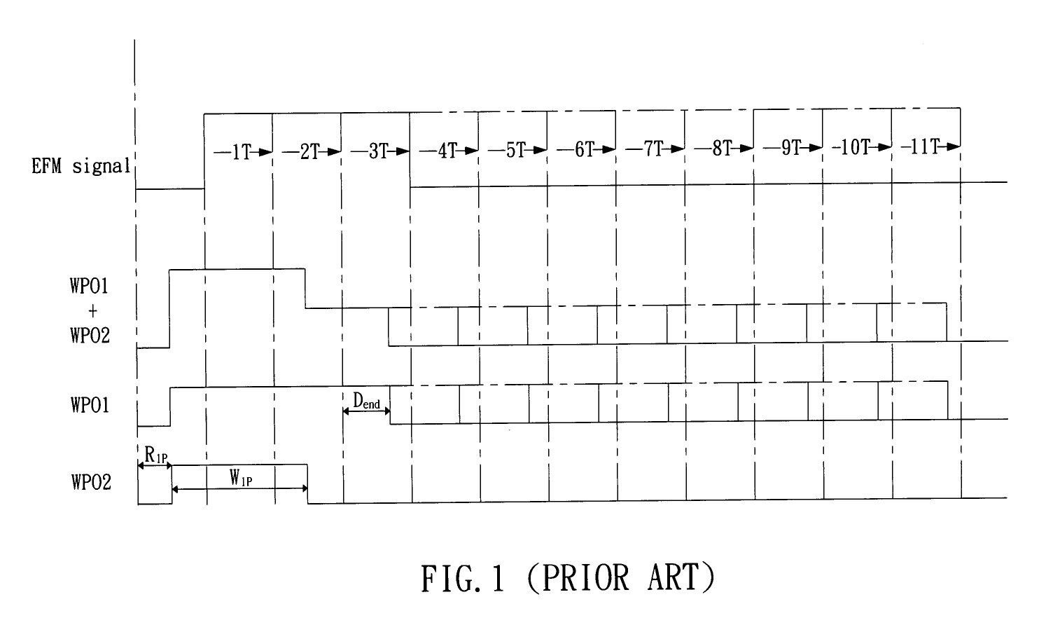

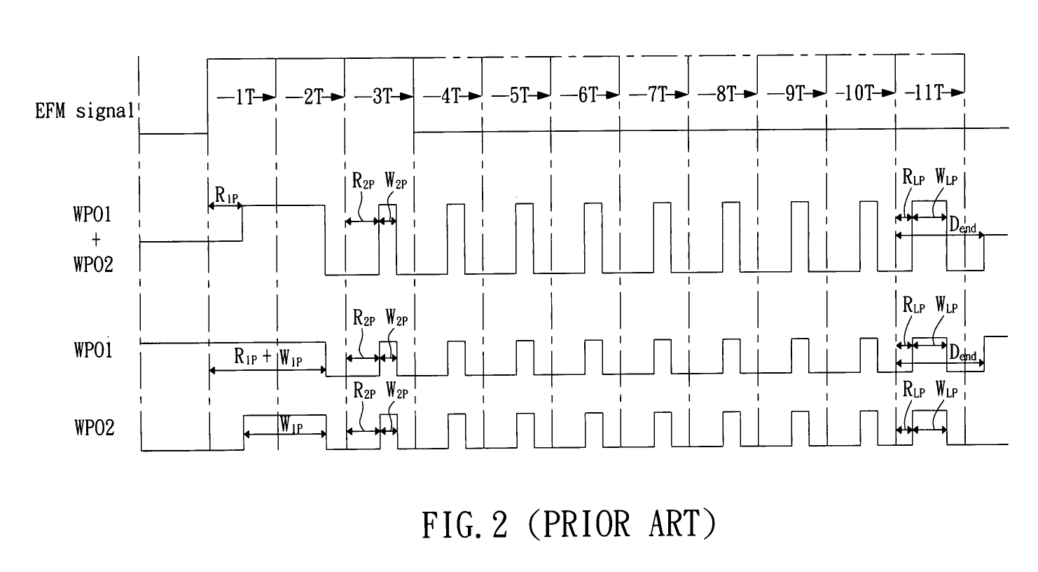

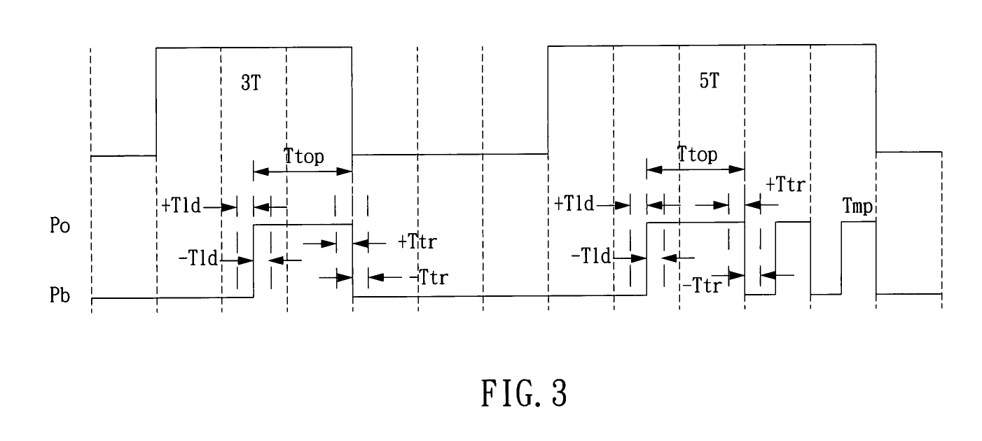

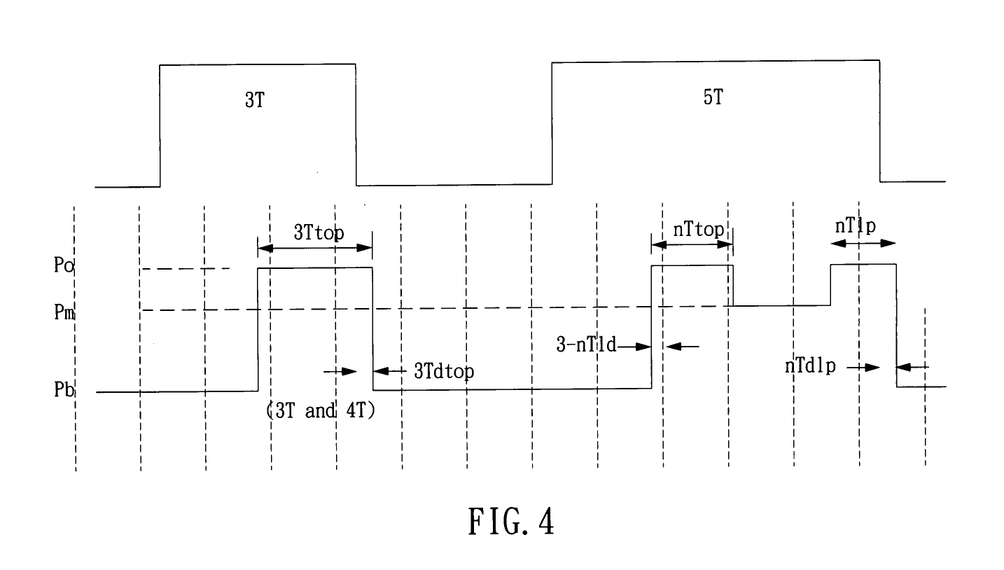

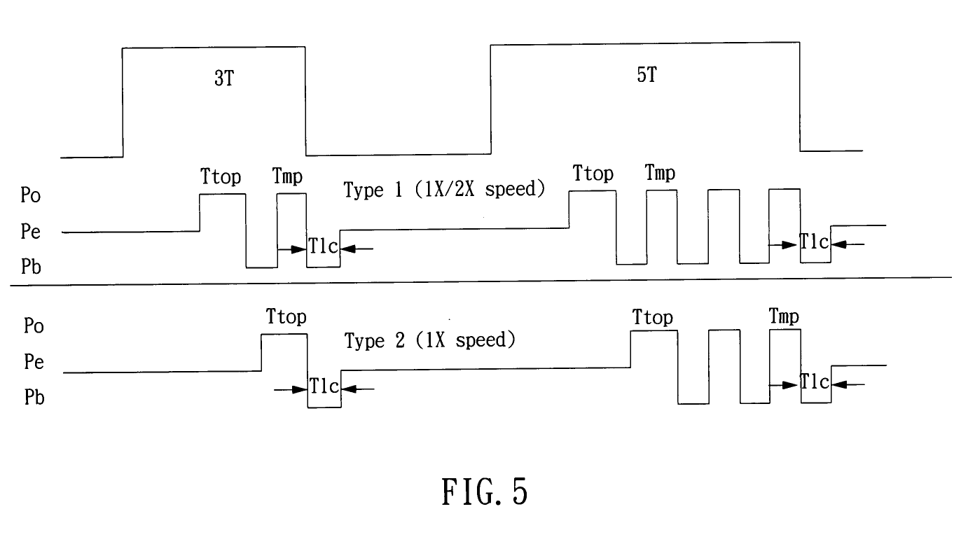

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

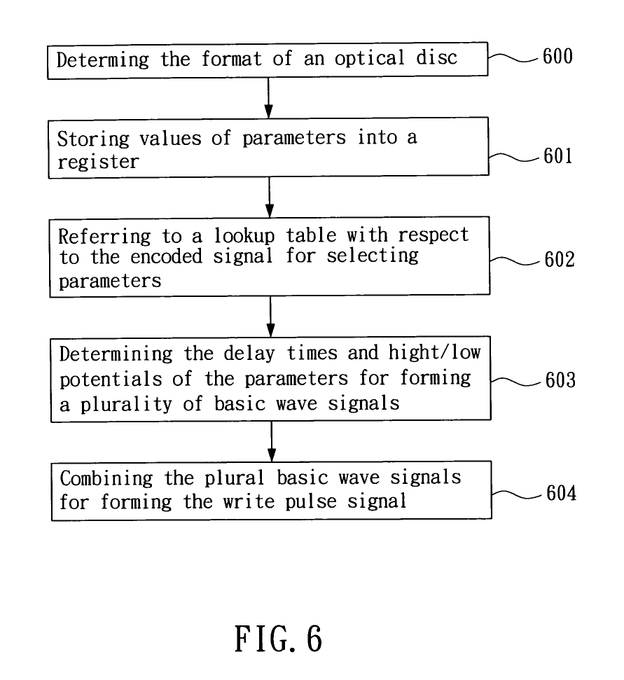

Please refer to FIG. 6 for the flow chart of the method for generating a write pulse signal in an optical disk drive according to a preferred embodiment of the present invention. In Step 600, the format of a duplicating optical disk is determined. To produce a write pulse signal, it is necessary to convert the duplicating data into channel bits by EFM and determine the EFM signal corresponding to such channel bits; wherein the number of cycles (T) of each section of the EFM signal ranges from 3T˜14T, which is used as an example.

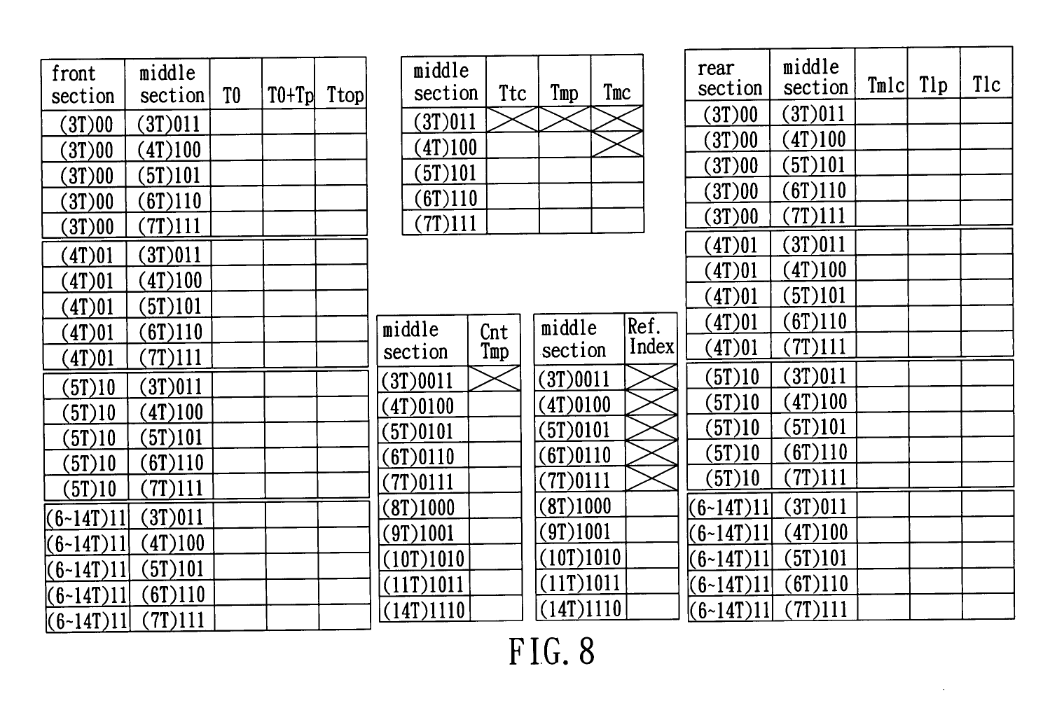

The present invention further provides a lookup table, and such lookup table integrates the parameters (as shown in FIG. 8 required for the CD (3T˜11T) or DVD (3T˜14T) so as to generate a write pulse signal and save the same into a register. To save the space of the registers, the parameters of the 5T˜7T could be used as those corresponding to the 8T˜14T through the reference index of Ref.Index, except for the parameter indicated by CntTmp. The above step constitutes Step 601.

The parameters can be found by referring to the lookup table with respect to each coded section of channel bits converted from the duplicating data. Therefore, parameters for generating write pulse can be obtained by referring to the lookup table with respect to the number of cycles (T) of each section of the EFM signal. The above step constitutes Step 602.

Therefore, after parameters for generating basic wave signals of the write pulse are obtained by referring to the lookup table with respect to the number of cycles (T) of each section of the EFM signal, the delay times and the high/low potentials of the parameters are used to define a plurality of basic wave signals. The above step constitutes Step 603.

Finally, the parameters obtained from each cycle point of the EFM signal by referring to the lookup table are used to establish several basic wave signals of the write pulse signal. These basic wave signals are combined into the desired write pulse signal. The step above constitutes Step 604.

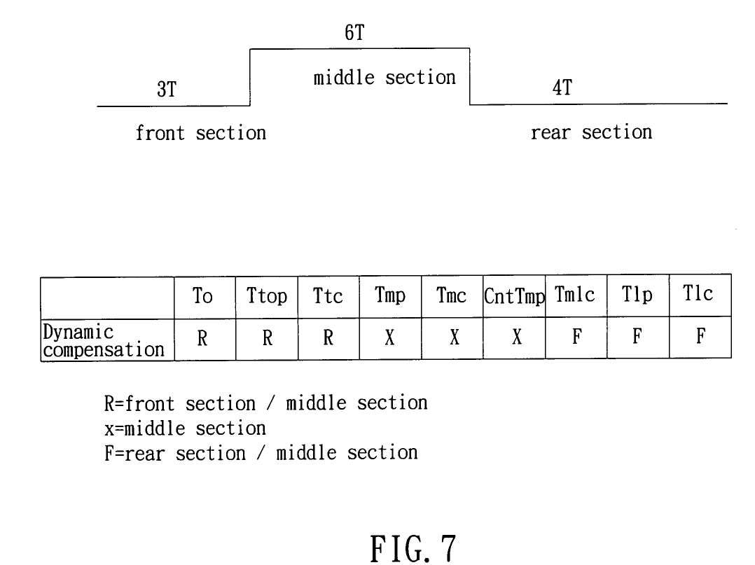

Please refer to FIG. 7 for an illustration showing the method for generating a write pulse signal in an optical disk drive according to a preferred embodiment of the present invention. An eight-bit data of 218₍₁₀₎ can be converted by EFM into a fourteen channel bit data as 10010000010001₍₂₎, where it is clear that the EFM signal corresponding to the channel bits is comprised of 3T, 6T and 4T. Such EFM produces a write pulse signal of 6T, and the 3T, 6T and 4T constitute the lookup table.

Please also refer to FIG. 8 for a lookup table according to a preferred embodiment of the present invention. Since part of the 6T is sandwiched between 3T and 4T as shown in the lookup table, that is, the front section is 3T and the rear section is 4T, therefore the parameters T₀, T_{pc}, Tₜₒₚ are selected according to the front section 3T and the middle section 6T; the parameters T_{tc}, Tₘₚ, T_{mc}, CntTmp are selected according to the middle section 6T; and the parameters T_{m1c}, T₁ₚ, T_{1c} are selected according to the rear section 4T and the middle section 6T. The parameter CntTmp determines the number of reoccurrences of Tₘₚ and T_{mc}. That is, Regardless of the value of the parameter Tₘₚ while CntTmp=0; Tₘₚ occurs once while CntTmp=1; Tₘₚ occurs twice and T_{mc} occurs once while CntTmp=2. In sum, Tₘₚ occurs n times and T_{mc} occurs (n−1) times while CntTmp=n. Therefore, for instance, if it is necessary to duplicate a data onto an optical disk, the successive parameters of T₀, T_{pc}, Tₜₒₚ, T_{tc}, Tₘₚ, T_{mc}, Tₘₚ, T_{m1c}, T₁ₚ and T_{1c} should be used for the write pulse signal (CntTmp=2).

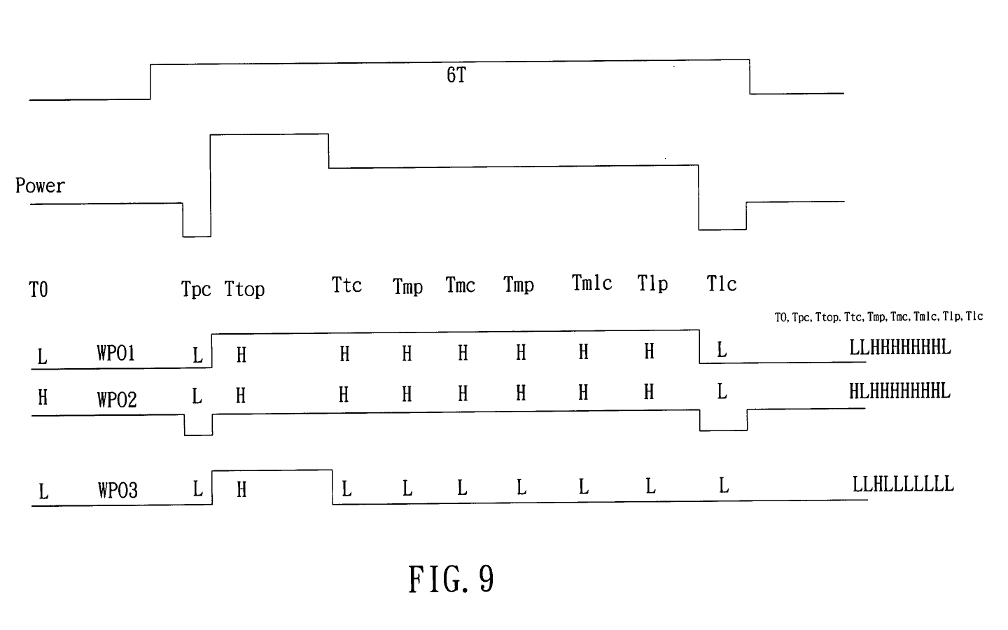

Please refer to FIG. 9 for is an illustration showing a write pulse signal of FIG. 7. Several basic wave signals wpo1, wpo2, wpo3 are used to generate a write pulse signal, and the high potential (H) or the low potential (L) of the parameters of several basic waves signals T₀, T_{pc}, Tₜₒₚ, T_{tc}, Tₘₚ, T_{mc}, Tₘₚ, T_{mc}, Tₘₚ, T_{m1c}, T₁ₚ, T_{1c} can be found by the EFM signal lookup table. These basic wave signals are combined to form the write pulse signal.

The parameters are used by the basic wave signals to establish each of the cycle points of the EFM signal. In other words, every parameter used by the basic wave signal is related to the cycle point of the EFM signal in addition to its sequence. For example, when the basic wave signal uses these parameters, it will compute the relation between the parameters and the cycle point of the EFM signal, which happens to be the location for recording the parameter conversion. Therefore, every parameter used by the basic wave signal is established at the cycle point of the EFM signal. The delay time of each parameter used by the basic wave signal defines the x-axis and the high/low potential of each parameter defines the y-axis as to form a single basic wave, and several basic wave signals are combined to produce a write pulse signal. Every basic wave signal has a set of high/low potentials of the parameters to define the y-axis, and the x-axis of the basic wave signal is defined by the parameters in the aforementioned way.

In summation of the description above, the present invention provides a method for generating a write pulse signal in an optical disk drives. With the parameter lookup table required for generating a write pulse signal and the point of using parameter being established at the cycle point of the encoded signal, various types of write pulse signals can be produced. Therefore, if an optical disk burner produces various types of write pulse signals according to the present invention, users do not have to worry about the compliance of the format of the burner with the duplicating optical disk, and thus greatly enhancing the convenience of duplicating an optical disk.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A method for generating a write pulse in an optical disk drives, comprising: determining an encoded signal;
providing a lookup table, the lookup table integrating a plurality of various types of parameters used by different cycle number of the encoded signal of the write pulse;
determining the parameters used by corresponding cycle number of the encoded signal of the write pulse by referring to the lookup table; and
forming the write pulse signal corresponding to the encoded signal according to the parameter obtained from the lookup table.

2. The method as recited in claim 1, wherein the encoded signal is substantially an eight to fourteen modulation coded signal.

3. The method as recited in claim 1, wherein the encoded signal is substantially an eight to sixteen modulation coded signal.

4. The method as recited in claim 1, wherein the lookup table integrates at least ten parameters.

5. The method as recited in claim 1, further comprising:
dividing the encoded signal into a plurality of sections, and referring to the lookup table respectively according to the cycle number representing each section of the encoded signal.

6. The method as recited in claim 1, further comprising:
combining a plurality of basic wave signals to form the write pulse signal, wherein the basic wave signals adopts the parameters obtained from the lookup table.

7. The method as recited in claim 6, further comprising:
determining a waveform potential of the basic wave signals according to a high/low potential represented by the values of the parameters.

8. The method as recited in claim 6, wherein the basic wave signals are parameters, which are used according to the cycle of the encoded signal.

9. The method as recited in claim 1 further comprising:
determining the format of a duplicating optical disk and then determining the encoded signal.
